(19) United States
(12) Patent Application Publication
(10) Pub. No.: US 2012/0293504 A1
(43) Pub. Date: Nov. 22, 2012

(54) SYSTEM AND METHOD FOR TRANSMITTING THREE-DIMENSIONAL IMAGE INFORMATION USING DIFFERENCE INFORMATION

(75) Inventors: Hyon Gon CHOO, Daejeon (KR); Jin Woong KIM, Daejeon (KR); Sung Wook MIN, Seoul (KR); Jae Hyun JUNG, Busan (KR); Ji Woon YEOM, Cheongwon-gun (KR); Yongjoo CHO, Seoul (KR); Minyoung KIM, Seoul (KR)

(73) Assignees: Electronics and Telecommunications Research Institute, Daejeon (KR); Sangmyung University, Council for Industry Academic Cooperation, Cheonan-si (KR); University-Industry Cooperation Group of Kyung Hee University, Yongin-si (KR)

(21) Appl. No.: 13/475,315

(22) Filed: May 18, 2012

(30) Foreign Application Priority Data
May 19, 2011 (KR) 10-2011-0047485

(51) Int. Cl. G06T 15/04; G06K 9/68

(52) U.S. Cl. 345/419; 382/154

(57) ABSTRACT

Provided is a three-dimensional (3D) image information transmitting system and method based on difference information. A 3D image information transmitting apparatus in the 3D image information transmitting system may include a difference information extractor to extract difference information by comparing a second composite texture image obtained by generating a composite of a first texture image and depth information with a second original texture image, and an image information transmitting unit to transmit 3D image information including the first texture image, the depth information, and the difference information.

### CROSS-REFERENCE TO RELATED APPLICATION

This application claims the benefit of Korean Patent Application No. 10-2011-0047485, filed on May 19, 2011, in the Korean Intellectual Property Office, the disclosure of which is incorporated herein by reference.

### BACKGROUND

1. Field of the Invention

The present invention relates to a three-dimensional (3D) image information transmitting system and method, and more particularly, to a 3D image information transmitting system and method that transmits, along with a left-eye texture image, difference information that may restore a right-eye texture image based on the left-eye texture image, so as to provide the same effect as when the left-eye texture image and the right-eye texture image are transmitted together.

2. Description of the Related Art

As a stereoscopic three-dimensional (3D) film market is being stimulated and a 3D television (TV) is widely propagated, research on a 3D image information generating technology and a transmission format is drawing greater global attention than before.

A conventional 3D image information transmitting method may include a method of transmitting 3D image information including a left-eye texture image and a right-eye texture image, a method of transmitting 3D image information including a left-eye texture image and a depth image, and a method of transmitting 3D image information including a left-eye texture image and depth information, and image information associated with an occlusion, occluded by an object and depth information.

However, the method of transmitting the 3D image information including the left-eye texture image and the right-eye texture image has a drawback in that the method requires twice an amount of transmission bandwidth used in a method of transmitting a single image. Also, the method of transmitting the 3D image information including the left-eye texture image and the depth image may require a post-processing so as to generate a 3D image. During the post-processing, information absent in the left-eye texture image may be omitted and thus, it may be difficult for a complete 3D image to be provided by this method.

The method of transmitting the 3D image information including the left-eye texture image and the depth information, and the image information associated with an occlusion occluded by an object and the depth information may provide a complete 3D image through a post-processing. However, the image information associated with the occlusion, occluded by the object and the depth information, has the same size as the left-eye texture image and the depth information and thus, the method may have a drawback in that an amount of data to be transmitted may be vast.

Accordingly, there is a desire for a method of generating and transmitting 3D image information that provides a complete 3D image through transmission of a small amount of data.

### SUMMARY

An aspect of the present invention provides a three-dimensional (3D) image information transmitting system and method that transmits 3D image information through use of difference information between a left-eye texture image and a right-eye texture image and thus, may transmit the 3D image information using a small amount of data.

Another aspect of the present invention also provides a 3D image information transmitting system and method that generates a right-eye texture image by generating a composite of a left-eye texture image and depth information, restores an original right-eye texture image by correcting the composite right-texture image based on difference information and thus, the same effect as when the right-eye texture image and the left-eye texture image are transmitted together may be obtained through transmission of the left-eye texture image.

According to an aspect of the present invention, there is provided a 3D image information transmitting apparatus, the apparatus including a difference information extractor to extract difference information by comparing a second composite texture image obtained by generating a composite of a first texture image and depth information with a second original texture image, and an image information transmitting unit to transmit 3D image information including the first texture image, the depth information, and the difference information,

According to another aspect of the present invention, there is provided a 3D image display apparatus, the apparatus including a texture image restoring unit to restore a second original texture image based on difference information and a second composite texture image obtained by generating a composite of a first texture image and depth information, and a 3D image display unit to display a 3D image based on the first texture image, the second original texture image, and the depth information.

According to still another aspect of the present invention, there is provided a 3D image information transmitting method, the method including extracting difference information by comparing a second composite texture image obtained by generating a composite of a first texture image and depth information with a second original texture image, and transmitting 3D image information including the first texture image, the depth information, and the difference information.

According to yet another aspect of the present invention, there is provided a 3D image display method, the method including restoring a second original texture image based on difference information and a second composite texture image obtained by generating a composite of a first texture image and depth information, and displaying a 3D image based on the first texture image, the second original texture image, and the depth information.

Additional aspects, features, and/or advantages of the invention will be set forth in part in the description which follows and, in part, will be apparent from the description, or may be learned by practice of the invention.

### EFFECT

Exemplary embodiments may provide a three-dimensional (3D) image information transmitting system and method that transmits 3D image information through use of difference information between a left-eye texture image and right-eye texture image and thus, transmission of the 3D image information may be performed through transmission of a small amount of data.

Exemplary embodiments may provide a 3D image information transmitting system and method that generates a right-eye texture image by generating a composite of a left-eye texture image and depth information, restores an original right-eye texture image by correcting the composite right-texture image based on difference information and thus, the same effect as when the right-eye texture image and the left-eye texture image are transmitted together may be obtained through transmission of the left-eye texture image.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a three-dimensional (3D) image information transmitting system according to an embodiment of the present invention;

FIG. 2 is a block diagram illustrating a 3D image information transmitting apparatus according to an embodiment of the present invention;

FIG. 3 is a block diagram illustrating a process of extracting difference information according to an embodiment of the present invention;

FIG. 4 is a block diagram illustrating an example of a process of generating 3D image information according to an embodiment of the present invention;

FIG. 5 is a flowchart illustrating a 3D image information generating method according to an embodiment of the present invention;

FIG. 6 is a block diagram illustrating a 3D image display apparatus according to an embodiment of the present invention;

FIG. 7 is a diagram illustrating an example of a process of restoring a second original texture image according to an embodiment of the present invention; and

FIG. 8 is a flowchart illustrating a 3D image display method according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

A three-dimensional (3D) image information transmitting method may be performed by a 3D image information transmitting system.

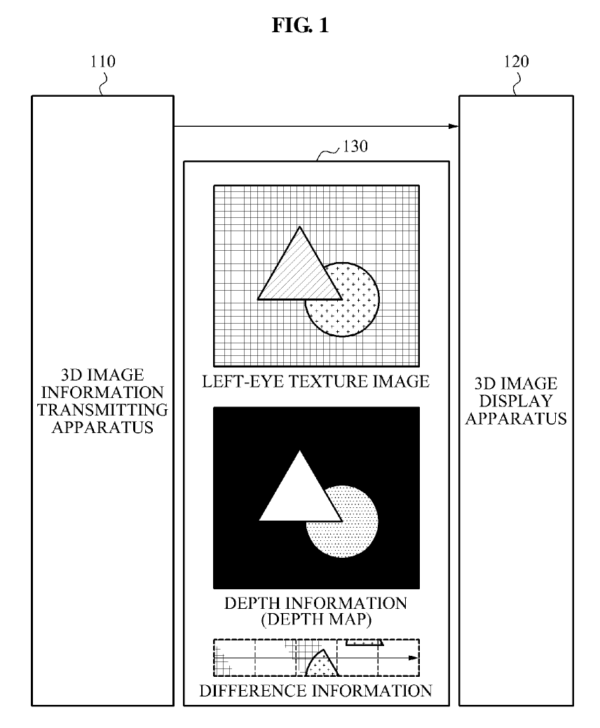

FIG. 1 illustrates a 3D image information transmitting system according to an embodiment of the present invention.

Referring to FIG. 1, the 3D image information transmitting system may include a 3D image information transmitting apparatus 110 and a 3D image display apparatus 120.

The 3D image information transmitting apparatus 110 may generate difference information based on a first texture image, a second original texture image, and depth information. In this example, the difference information may not be an occlusion that is occluded by an object and is not displayed on the first texture image, but instead image information associated with the occlusion displayed on the second original texture image. The 3D image information transmitting apparatus 110 may generate 3D image information 130 including the first texture image, the depth information, and the difference information, and may transmit the 3D image information 130 to the 3D image display apparatus 120. The first texture image may correspond to a left-eye texture image and the second original texture image may correspond to a right-eye texture, or the first texture image may correspond to a right-eye texture image and the second original texture image may correspond to a left-eye texture

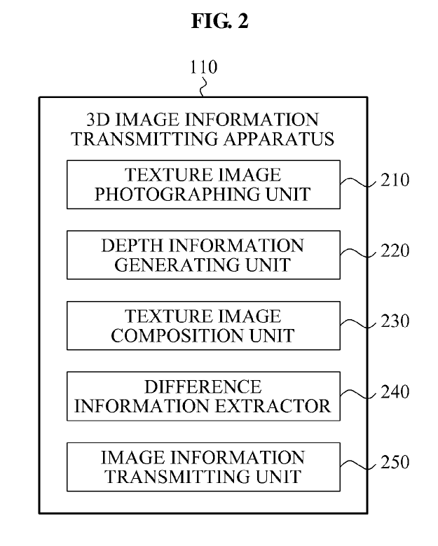

The detailed configuration and operation of the 3D image information transmitting apparatus 110 may be described in detail with reference to FIGS. 2 through 5.

The 3D image display apparatus 120 may restore the second original texture image based on the 3D image information 130, and may generate a 3D image based on the restored second original texture image and the first texture image and the depth information included in the 3D image information 130, so as to display the 3D image to a user.

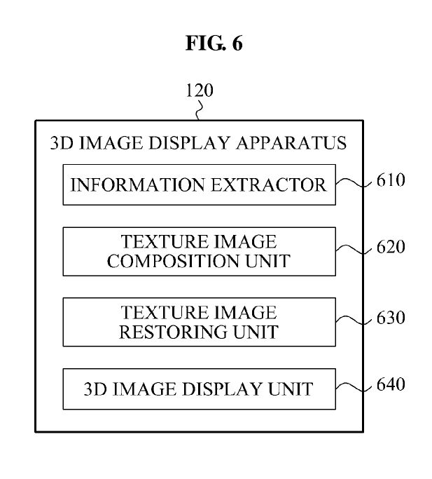

The detailed configuration and operation of the 3D image display apparatus 120 may be described in detail with reference to FIGS. 6 through 8.

FIG. 2 illustrates the 3D image information transmitting apparatus 110 according to an embodiment of the present invention

The 3D image information transmitting apparatus 110 may include a photographing unit 210, a depth information generating unit 220, a texture image composition unit 230, a difference information extractor 240, and an image information transmitting unit 250.

The texture image photographing unit 210 may obtain a first texture image and a second original texture image for an object of which 3D image information is desired by the user. For example, the photographing unit 210 may be a binocular camera.

The depth information generating unit 220 may obtain depth information associated with the object and a background. For example, the depth information generating unit 220 may be a depth camera that obtains depth information by capturing the object and the background. The depth information generating unit 220 may extract the depth information based on the first texture image and the second original texture image captured by the photographing unit 210. In this example, the depth information may be a depth map or a disparity map between a left image and a right image.

The texture image composition unit 230 may generate a second composite texture image by generating a composite of the first texture image and the depth information. In this example, the second composite texture image generated by the texture image composition unit 230 may be a texture image including an occlusion generated due to a difference between the first texture image and the second original texture image. When the texture image composition unit 230 generates the second composite texture image by generating a composite of the first texture image and the depth information, image information associated with the occlusion that is only observed from a camera located in a side of a right-eye may be absent in the composition. In this example, the information corresponding to the occlusion may be empty or may be filled with adjacent values.

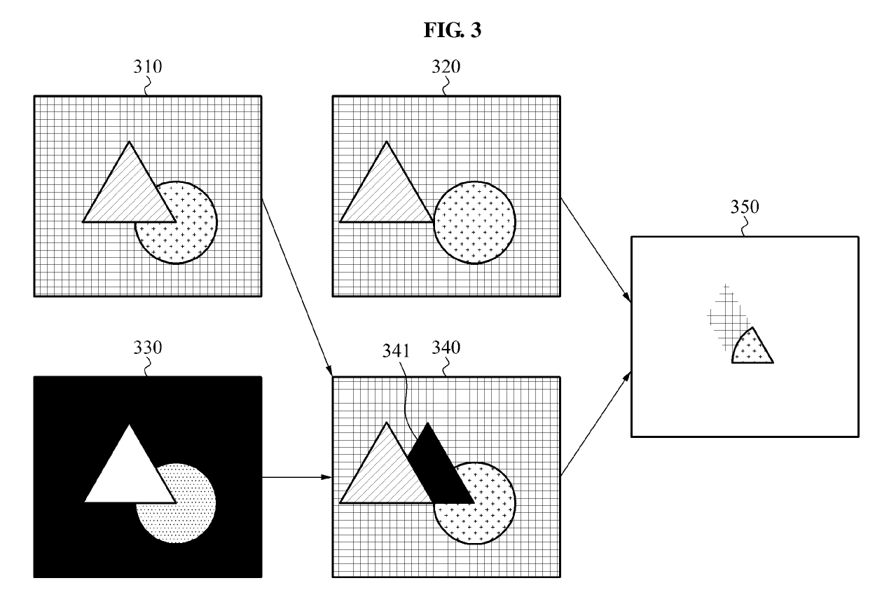

The difference information extractor 240 may extract difference information by comparing the second composite texture image generated by the texture image composition unit 230 with the second original texture image captured by the photographing unit 210. In this example, the second original texture image may be an original of the second composite texture image. A process in which the difference information extractor 240 extracts the difference information may be described in detail with reference to FIG. 3.

The image information transmitting unit 250 may generate 3D image information based on the first texture image, the depth information, and the difference information. The image information transmitting unit 250 may compress the first texture image and the depth information, and may convert the difference information into a form of a one-dimensional (1D) array, so as to generate the 3D image information.

The image information transmitting unit 250 may transmit the generated 3D image information to the 3D image display apparatus 120.

FIG. 3 illustrates an example of a process of extracting difference information 350 according to an embodiment of the present invention.

The texture image composition unit 230 may generate a second composite image 340 by generating a composite of a first texture image 310 and depth information 330.

In this example, the first texture image 310 and a second original texture image 320 may be different from one another, due to a location of a camera that captures each image, as illustrated in FIG. 3. A triangle is disposed on a circle in the first texture image 310, whereas a triangle is not disposed on a circle in the second original texture image 320. Accordingly, the difference information 350 corresponding to an occlusion 341 that is occluded by the triangle is absent in the first texture image 310.

Accordingly, when the texture image composition unit 230 generates the second composite texture image based on the first texture image 310, image information associated with the occlusion 341 corresponding to the difference information 350 is absent and may not be combined with the depth information and thus, an image may not be displayed on the occlusion 341 corresponding to the difference information 350.

Accordingly, the difference information extractor 240 may compare the second composite texture image 340 generated by the texture image composition unit 230 with the second original texture image 320 captured by the photographing unit 210, so as to determine a location and a size of the occlusion 341, and may extract difference information 350 corresponding to image information corresponding to the occlusion 341 from the second original texture image 320.

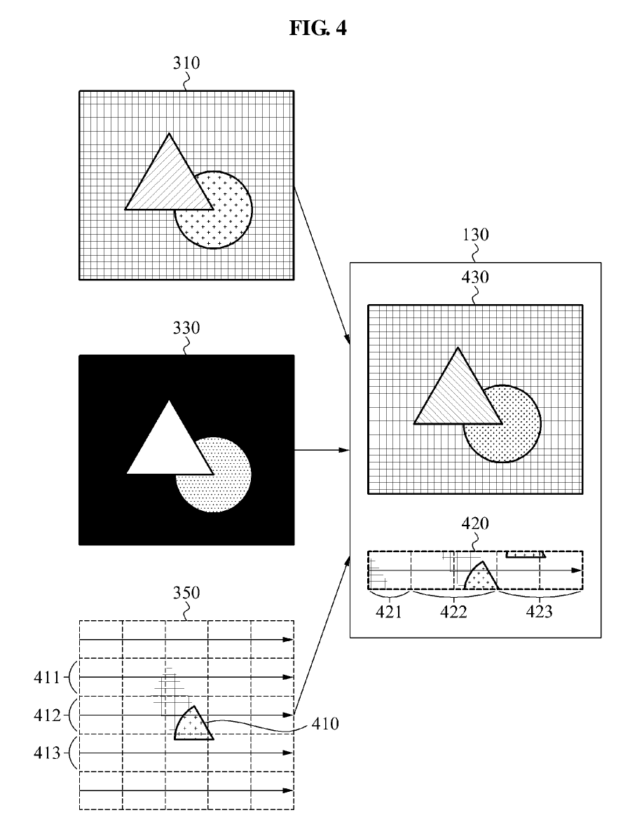

FIG. 4 illustrates an example of a process of generating 3D image information according to an embodiment of the present invention.

The image information transmitting unit 250 may convert the difference information 350 into a form of a 1D array 420. The image information transmitting unit 250 may scan the difference information 350 at 1D array intervals 411, 412, and 413 so as to extract regions 421, 422, and 423, respectively, including effective pixels 410 corresponding to the difference information 350. The image information transmitting unit 250 may sequentially combine the regions 421, 422, and 423 including the effective pixels 410 so as to generate difference information 420 converted into the form of the 1D array. In this example, the region 421 may be a region including effective pixels scanned at the interval 411, the region 422 may be a region including effective pixels scanned at the interval 412, and the region 423 may be a region including effective pixels scanned at the interval 413. In this example, the image information transmitting unit 250 may not convert the difference information 350 when an amount of the difference information 350 is not large.

Subsequently, the image information transmitting unit 250 may obtain information 430 by compressing the first texture image 310 and the depth information 330, based on a mutual similarity.

The image information transmitting unit 250 may add the difference information 420 converted into the form of a 1D array to the information 430 obtained by compressing the first texture image and the depth information 330, so as to generate the 3D image information.

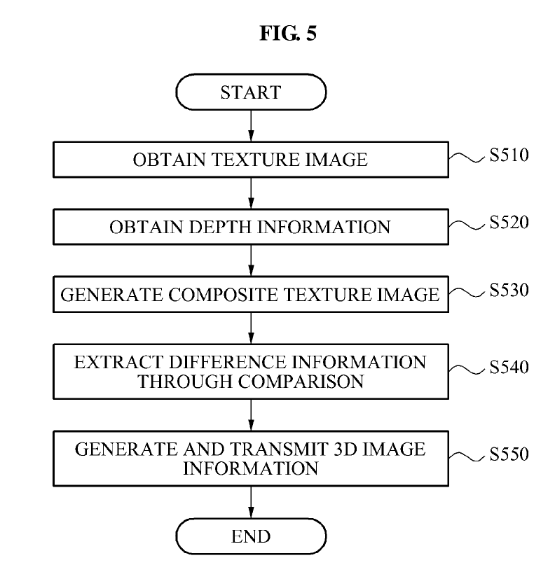

FIG. 5 illustrates a 3D image information generating method according to an embodiment of the present invention.

In operation S510, the photographing unit 210 may obtain a first texture image and a second original texture image for an object of which 3D image information is desired by a user.

In operation S520, the depth information generating unit 220 may obtain depth information associated with the object and a background. In this example, the depth information generating unit 220 may extract the depth information based on the first texture image and the second original texture image obtained in operation S510.

In operation S530, the texture image composition unit 230 may generate a second composite texture image by generating a composite of the first texture image obtained in operation S510 and the depth information obtained in operation S520. Also, the texture image composition unit 230 may omit operations S510 and S520, and may generate a second composite texture image by generating a composite of a first texture image and depth information input by the user.

In operation S540, the difference information extractor 240 may extract difference information by comparing the second composite texture image generated in operation S530 to the second original texture image obtained in operation S510.

In operation S550, the image information transmitting unit 250 may generate 3D image information based on the first texture image obtained in operation S510, the depth information obtained in operation S520, and the difference information extracted in operation S540. The image information transmitting unit 250 may compress the first texture image and the depth information, may convert the difference information into a form of a 1D array, and may combine information obtained through the compression and the converted difference information so as to generate the 3D image information.

The image information transmitting unit 250 may transmit the generated 3D image information to the 3D image display apparatus 120.

FIG. 6 illustrates the 3D image display apparatus 120 according to an embodiment of the present invention.

The 3D image display apparatus 120 may include an information extractor 610, a texture image composition unit 620, a texture image restoring unit 630, and a 3D image display unit 640.

The information extractor 610 may receive 3D image information 130 from the 3D image information transmitting apparatus 110, and may extract a first texture image, depth information, and difference information from the received 3D image information 130.

The texture image composition unit 620 may generate a second composite texture image by generating a composite of the first texture image and the depth information extracted from the information extractor 610. In this example, the second composite texture image generated by the texture image composition unit 620 may be a texture image including an occlusion associated with a difference between the first texture image and a second original texture image.

The texture image restoring unit 630 may restore the second original texture image based on the second composite texture image generated by the texture image composition unit 620 and the difference information extracted by the information extractor 610.

The texture image restoring unit 630 may search for the occlusion from the second composite texture image, and may restore an image associated with the occlusion based on the difference information, so as to restore the second original texture image.

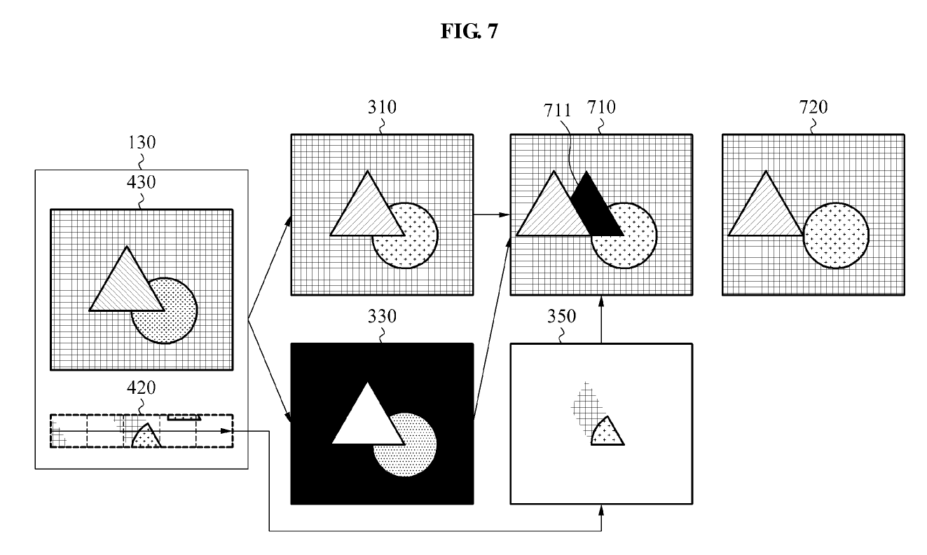

A process of restoring the second original texture image may be described in detail with reference to FIG. 7.

The 3D image display unit 640 may display a 3D image based on the first texture image and the depth information extracted by the information extractor 610 and the second original texture image restored by the texture image restoring unit 630.

FIG. 7 illustrates an example of a process of restoring a second original texture image 720 according to an embodiment of the present invention.

An information extractor 610 may extract, from the 3D image information 130, the first texture image 310 and the depth information 330, and depth information 350. In this example, the 3D image information 130 may include the information 430 obtained by compressing the first texture image 310 and the depth information 330 and the difference information 420 converted into a form of a 1D array.

The information extractor 610 may decompress the information 430, and may extract the first texture image 310 and the depth information 330. The information extractor 610 may restore the difference information 350 based on the difference information 420 converted into the form of the 1D array. For example, the difference information 350 corresponding to the occlusion 341 where an image is absent, based on locations of regions 421, 422, and 423 including effective pixels 410.

Subsequently, the texture image composition unit 620 may generate a second composite texture image 710 by generating a composite of the first texture image 310 and the depth information 330 extracted by the information extractor 610. In this example, the second composite texture image 710 generated by the texture image composition unit 620 may be a texture image including an occlusion 711 associated with a difference between the first texture image 310 and the second original texture image 720.

The texture image restoring unit 630 may search for the occlusion 711 from the second composite texture image 710, and may insert the difference information 350 to the retrieved occlusion 711 so as to restore the second original texture image 720.

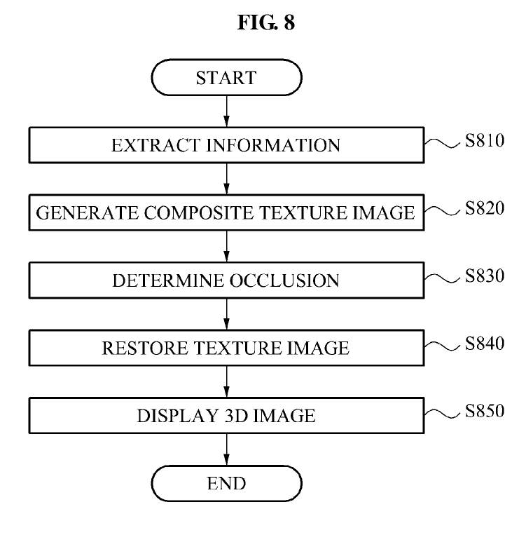

FIG. 8 illustrates a 3D image display method according to an embodiment of the present invention.

In operation S810, the information extractor 610 may extract, from 3D image information, a first texture image and depth information, and difference information.

In operation S820, the texture image composition unit 620 may generate a second composite texture image by generating a composite of the first texture image and the depth information extracted in operation S810.

In operation S830, the texture image restoring unit 630 may search for an occlusion from the second composite texture image generated in operation S820.

In operation S840, the texture image restoring unit 630 may insert the difference information extracted in operation S810 to the retrieved occlusion so as to restore a second original texture image.

In operation S850, the 3D image display unit 640 may display a 3D image based on the first texture image and the depth information extracted in operation S810 and the second original texture image restore in operation S840.

According to the exemplary embodiments, transmission of 3D image information may be executed using a small amount of information by transmitting difference information between a left-eye texture image and a right-eye texture image.

According to the exemplary embodiments, a right-eye texture image is generated by generating a composite of a left-eye texture image and depth information, an original right-eye texture image is restored by correcting the composite right-eye texture image based on difference information and thus, the same effect as when the right-eye texture image and the left-eye texture image are transmitted together may be obtained through transmission of the left-eye texture image.

Although the exemplary embodiments describe the use of a difference with a right-eye texture image based on a left-eye texture image, composite images having different viewpoints corresponding to various angles may be generated through use of texture image and depth image associated with a single point of view, and image information associated with a multi-view 3D image obtained based on difference information between the composite images and the texture image may be transmitted.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A three-dimensional (3D) image information transmitting apparatus, the apparatus comprising:
a difference information extractor to extract difference information by comparing a second composite texture image obtained by generating a composite of a first texture image and depth information with a second original texture image; and
an image information transmitting unit to transmit 3D image information including the first texture image, the depth information, and the difference information,
wherein the difference information is an occlusion that is included in the second original texture image, and is absent in the first texture image.

2. The apparatus of claim 1, wherein:
the first texture image is a left-eye texture image and the second original texture image is a right-eye texture image; or
the first texture image is a right-eye texture image and the second original texture image is a left-eye texture image.

3. The apparatus of claim 1, wherein the image information transmitting unit converts the difference information into a form of a one-dimensional (1D) array so as to generate the 3D image information.

4. The apparatus of claim 1, wherein the image information transmitting unit compresses the first texture image and the depth information based on a mutual similarity.

5. A three-dimensional (3D) image display apparatus, the apparatus comprising:
a texture image restoring unit to restore a second original texture image based on difference information and a second composite texture image obtained by generating a composite of a first texture image and depth information; and
a 3D image display unit to display a 3D image based on the first texture image, the second original texture image, and the depth information,
wherein the difference information is an occlusion that is included in the second original texture image and is absent in the first texture image.

6. The apparatus of claim 5, wherein:
the first texture image is a left-eye texture image and the second original texture image is a right-eye texture image; or
the first texture image is a right-eye texture image and the second original texture image is a left-eye texture image.

7. The apparatus of claim 5, wherein the second composite texture image is a texture image including the occlusion associated with a difference between the first texture image and the second original texture image.

8. The apparatus of claim 7, wherein the texture image restoring unit searches for the occlusion from the second composite texture image, and restores the second original texture image including the occlusion based on the difference information.

9. The apparatus of claim 5, further comprising:
an information extractor to receive 3D image information from the 3D image information transmitting apparatus, and to extract the first texture image, the depth information, and the difference information from the 3D image information.

10. A method of transmitting a three-dimensional (3D) image information, the method comprising:
extracting difference information by comparing a second composite texture image obtained by generating a composite of a first texture image and depth information with a second original texture image; and
transmitting 3D image information including the first texture image, the depth information, and the difference information,
wherein the difference information is an occlusion that is included in the second original texture image and is absent in the first texture image.

11. The method of claim 10, wherein:
the first texture image is a left-eye texture image and the second original texture image is a right-eye texture image; or
the first texture image is a right-eye texture image and the second original texture image is a left-eye texture image.

12. The method of claim 10, wherein the transmitting comprises:
converting the difference information into a form of a one-dimensional (1D) array so as to generate the 3D image information.

13. The method of claim 10, wherein the transmitting comprises:
compressing the first texture image and the depth information based on a mutual similarity.

14. A three-dimensional (3D) image display method, the method comprising:
restoring a second original texture image based on difference information and a second composite texture image obtained by generating a composite of a first texture image and depth information; and
displaying a 3D image based on the first texture image, the second original texture image, and the depth information, wherein the difference information is an occlusion that is included in the second original texture image and is absent in the first texture image.

15. The method of claim 14, wherein:
the first texture image is a left-eye texture image and the second original texture image is a right-eye texture image; or the first texture image is a right-eye texture image and the second original texture image is a left-eye texture image.

16. The method of claim 14, wherein the second composite texture image is a texture image including the occlusion associated with a difference between the first texture image and the second original texture image.

17. The method of claim 16, wherein the restoring comprises:
searching for the occlusion from the second composite texture image; and
restoring the second original texture image displaying an image associated with the occlusion through use of the difference information.

18. The method of claim 14, further comprising:
receiving the 3D image information from a 3D image information transmitting apparatus; and
extracting, from the 3D image information, the first texture image, the depth information, and the difference information.
